(19) United States
(12) Patent Application Publication
(10) Pub. No.: US 2010/0238087 A1
(43) Pub. Date: Sep. 23, 2010

(54) ANTENNA FOR CONTROLLING A DIRECTION OF A RADIATION PATTERN

(75) Inventors: Pil-Gyu Jung, Seoul (KR); Seung-Chul Lee, Busan (KR); Gi-Nam Im, Seoul (KR)

Correspondence Address: EDWARDS ANGELL PALMER & DODGE LLP, P.O. BOX 55874, BOSTON, MA, 02205, US

(73) Assignee: ACE ANTENNA CORPORATION, Incheon (KR)

(21) Appl. No.: 12/681,490

(22) PCT Filed: Oct. 19, 2007
(86) PCT No.: PCT/KR07/05138

§ 371 Date: Apr. 2, 2010

(30) Foreign Application Priority Data
Oct. 5, 2007 (KR) 10-2007-0100541

(51) Int. Cl. H01Q 21/00; H01Q 9/16

(52) U.S. Cl. 343/810

(57) ABSTRACT

An antenna for compensating a phase of a current passing to a dipole member so as to prevent a shift phenomenon of a radiation pattern is disclosed. The antenna includes dipole members, and a feeding section connected to the dipole members, and configured to have at least two feeding points for providing current inputted from an outside device to the dipole members. Here, a first feeding point of the feeding points is connected to a second feeding point of the feeding points, the current is provided to the second feeding point through the first feeding point, and at least one of a slit and a projection member is formed to one or more of the dipole members.

### TECHNICAL FIELD

Example embodiment of the present invention relates to an antenna, more particularly relates to an antenna for compensating a phase of a current passing to a dipole member, thereby preventing a shift phenomenon of a radiation pattern.

### BACKGROUND ART

An antenna transmits or receives an electromagnetic wave by radiating a radiation pattern, and has usually structure shown in below FIG. 1.

FIG. 1 is a plan view illustrating a common antenna.

Referring to FIG. 1, the antenna generates a dual polarization, and includes a first dipole member 100, a second dipole member 102, a third dipole member 104, a fourth dipole member 106 and a feeding section 108.

The feeding section 108 has a first feeding point 130A, a second feeding point 130B, a third feeding point 130C, a fourth feeding point 130D, a first connection line 132A and a second connection line 132B.

The first feeding point 130A is connected to the first dipole member 100, and receives a current from an outside device.

The second feeding point 130B is connected to the second dipole member 102, and receives a current from an outside device.

The third feeding point 130C is connected to the third dipole member 104, and is connected to the first feeding point 130A through the first connection line 132A. Here, some of the current received to the first feeding point 130A is provided to the third feeding point 130C through the first connection line 132A.

The fourth feeding point 130D is connected to the fourth dipole member 106, and is connected to the second feeding point 130B through the second connection line 132B. Here, some of the current received to the second feeding point 130B is provided to the fourth feeding point 130D through the second connection line 132B.

Hereinafter, a radiation pattern radiated from the antenna will be described in detail.

FIG. 2 is a plan view illustrating phase difference of a current in the antenna in FIG. 1. FIG. 3 is a plan view illustrating a radiation pattern of the antenna in FIG. 1.

As shown in FIG. 2, the current inputted to the first feeding point 130A is applied to each of the dipole members 100, 102, 104 and 106, and thus electric fields are generated by the current applied to the dipole members 100, 102, 104 and 106. Then, the electric fields are synthesized through a vector composition method, and so +45° polarization is generated as shown in FIG. 3.

In this case, a distance POP1 between the first feeding point 130A and an edge of the first dipole member 100 and a distance POP2 between the first feeding point 130A and an edge of the fourth dipole member 106 are (a+b), respectively. However, a distance POP3 between the first feeding point 130A and an edge of the second dipole member 102 and a distance POP4 between the first feeding point 130A and an edge of the third dipole member 104 are (a+b+c), respectively.

As a result, a first phase of a sub-current provided from the first feeding point 130A to the first dipole member 100 of the inputted current and a fourth phase of a fourth sub-current provided from the first feeding point 130A to the fourth dipole member 106 have the same value. However, the first phase and the fourth phase are different from a second phase of a second sub-current provided from the first feeding point 130A to the second dipole member 102 and a third phase of a third sub-current provided from the first feeding point 130A to the third dipole member 104.

Accordingly, a problem exists in that a major axis 300 of +45° polarization generated by the dipole members 100, 102, 104 and 106 is shifted in a right direction of +45° axis 302 as shown in FIG. 3.

This shift phenomenon is also generated in a radiation pattern of −45° polarization. Hence, directions of +45° polarization and -45 ° polarization may be different. As a result, it is difficult to radiate a main beam in a desired direction. Specially, this shift phenomenon of the radiation pattern in a low frequency band is greater than that of the radiation pattern in a high frequency band.

### DISCLOSURE

### Technical Problem

Accordingly, the present invention is provided to substantially obviate one or more problems due to limitations and disadvantages of the related art.

Example embodiment of the present invention provides an antenna having a dipole member to which a slit or/and a projection member is formed, and for compensating a phase of a current passing to the dipole member, thereby preventing a shift phenomenon of a radiation pattern.

### Technical Solution

An antenna according to one example embodiment of the present invention includes dipole members; and a feeding section connected to the dipole members, and configured to have at least two feeding points.

Here, a first feeding point of the feeding points is connected to a second feeding point of the feeding points, a first sub-current of a current inputted to the first feeding point from an outside device is applied to a first dipole member coupled to the first feeding point, a second sub-current of the current is applied to a second dipole member through the first feeding point and the second feeding point, and at least one phase compensating section for compensating phase of the first sub-current is formed to the first dipole member.

The phase compensating section is a slit or a projection member.

The slit or the projection member has multi-step shape.

The first dipole member includes a radiation member; and a feeding line member configured to connect the radiation member to the first feeding point. Here, the phase compensating section is formed to one or more of the radiation member and the feeding line member.

At least two phase compensating sections are formed to the radiation member or the feeding line member.

The feeding section further includes a connection line for connecting the first feeding point to the second feeding point, wherein sum of depths of the phase compensating sections is substantially identical to length of the connection line.

The feeding section further includes a connection line for connecting the first feeding point to the second feeding point. Here, a first dipole member connected to the first feeding point includes a first radiation member; and a first feeding line member configured to connect the first radiation member to the first feeding point. In addition, a second dipole member connected to the second feeding point includes a second radiation member; and a second feeding line member configured to the second radiation member to the second feeding point, and wherein a distance between the first feeding point and an edge of the first radiation member is substantially identical to that between the first feeding point and an edge of the second radiation member.

The feeding section further includes a connection line for connecting the first feeding point to the second feeding point. Here, a first dipole member connected to the first feeding point includes a first radiation member; and a first feeding line member configured to connect the first radiation member to the first feeding point. Additionally, a second dipole member connected to the second feeding point includes a second radiation member; and a second feeding line member configured to the second radiation member to the second feeding point, and wherein a phase of the first sub-current applied from the first feeding point to an edge of the first radiation member is substantially identical to that of the second sub-current applied from the first feeding point to an edge of the second radiation member.

The feeding section further includes a first connection line configured to connect the first feeding point to the second feeding point; a third feeding point; a fourth feeding point; and a second connection line configured to connect the third feeding point to the fourth feeding point. Here, the second connection line crosses over the first connection line, given current is provided to the fourth feeding point through the third feeding point, a first phase compensating section is formed to a first radiation member connected to the first feeding point, a second phase compensating section is formed to a second radiation member connected to the third feeding point, and the first phase compensating section and the second phase compensating section are symmetrically disposed.

The dipole members include a first folded dipole member to a fourth folded dipole member. Here, the feeding section includes a first feeding point connected to the first folded dipole member; a second feeding point connected to the second folded dipole member; a third feeding point connected to the third folded dipole member; and a fourth feeding point connected to the fourth folded dipole member. In addition, the second sub-current is provided to the second feeding point through the first feeding point, a third sub-current is provided to the fourth feeding point through the third feeding point, and a phase compensating section is formed to at least one of the first folded dipole member and the third folded dipole member.

The phase compensating section is formed to at least one of an outline and inner line of corresponding folded dipole member.

The antenna is one of radiation devices included an array antenna.

An antenna according to another example embodiment of the present invention includes a first feeding point; a second feeding point connected to the first feeding point; a first dipole member and a second dipole member connected to the first feeding point; and a third dipole member and a fourth dipole member connected to the second feeding point. Here, at least three of a first current, a second current, a third current and a fourth current have the same phase, and wherein the first current is provided from the first feeding point to an edge of the first dipole member, the second current is provided from the first feeding point to an edge of the second dipole member, the third current is provided from the first feeding point to an edge of the third dipole member through the second feeding point, and the fourth current is provided from the first feeding point to an edge of the fourth dipole member through the second feeding point.

At least three of a first distance between the first feeding point and the edge of the first dipole member, a second distance between the first feeding point and the edge of the second dipole member, a third distance from the first feeding point and to the edge of the third dipole member through the second feeding point and a fourth distance from the first feeding point to the edge of the fourth dipole member through the second feeding point have the same length.

An antenna according to still another example embodiment of the present invention includes a first feeding point; a second feeding point connected to the first feeding point; a first dipole member and a second dipole member connected to the first feeding point; and a third dipole member and a fourth dipole member connected to the second feeding point. Here, a give polarization is generated by summing a first electric field by a first current applied from the first feeding point to the first dipole member, a second electric field by a second current applied from the first feeding point to the second dipole member, a third electric field by a third current applied from the first feeding point to the third dipole member through the second feeding point and a fourth electric field by a fourth current applied from the first feeding point to the fourth dipole member through the second feeding point through a vector composition method, and wherein phase of at least one of the currents is compensated so that a major axis of the generated polarization is substantially identical to a corresponding polarization axis.

A slit or a projection member for compensating phase is formed to the first dipole member or the second dipole member, and wherein width and depth (height) of the slit (projection member) is set so that the major axis of the generated polarization is substantially identical to a corresponding polarization axis.

### Advantageous Effects

An antenna of the present invention radiates a radiation pattern using a vector composition method. In addition, a slit or/and a projection member is formed to a dipole member in the antenna so that a phase of a current provided from a feeding point to the dipole member is compensated. Accordingly, a shift phenomenon may be not occurred to the radiation pattern radiated from the antenna. In this case, direction of +45° polarization may be substantially identical to that of −45° polarization, and thus a user may easily radiate a main beam in a desired direction.

In an array antenna of the present invention, a slit or/and a projection member is formed at a radiating member in the array antenna, thereby adjusting a radiation pattern outputted from the array antenna in a desired direction.

### DESCRIPTION OF DRAWINGS

Example embodiments of the present invention will become more apparent by describing in detail example embodiments of the present invention with reference to the accompanying drawings, in which:

FIG. 1 is a plan view illustrating a common antenna;

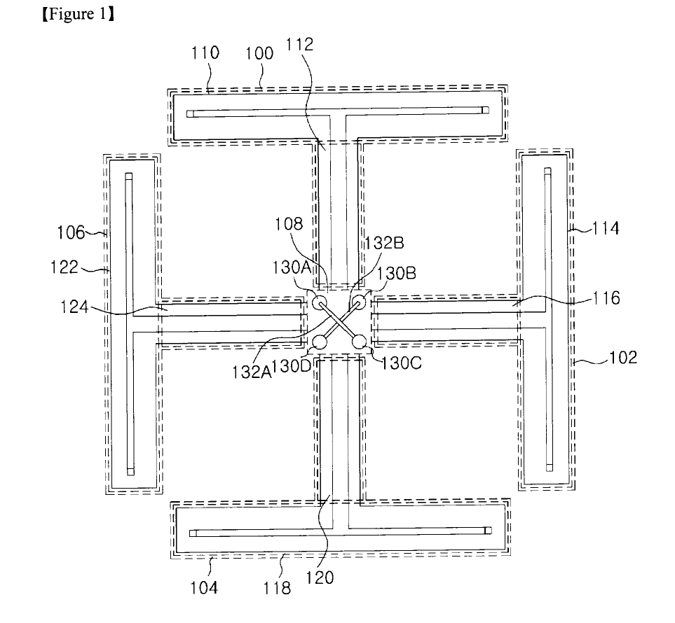

FIG. 2 is a plan view illustrating phase difference of a current in the antenna in FIG. 1;

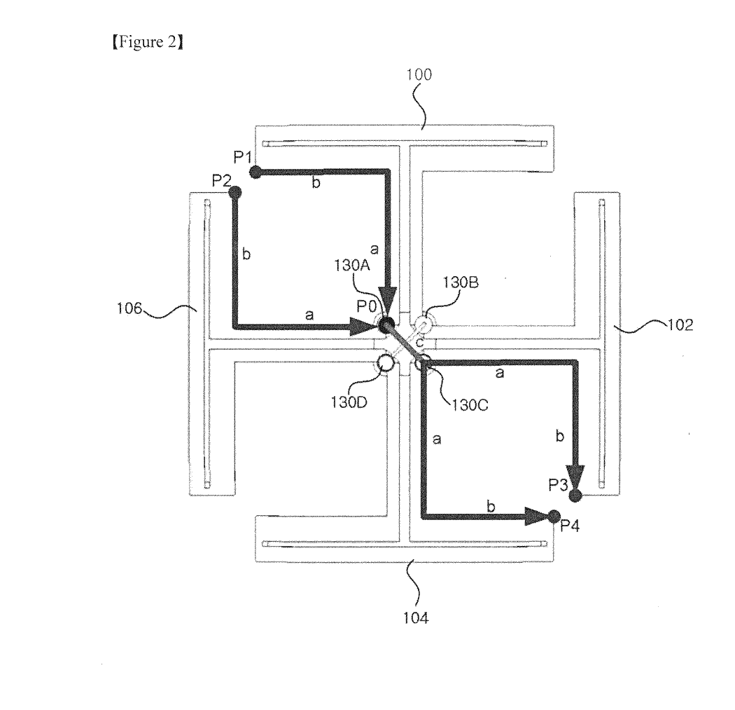

FIG. 3 is a plan view illustrating a radiation pattern of the antenna in FIG. 1;

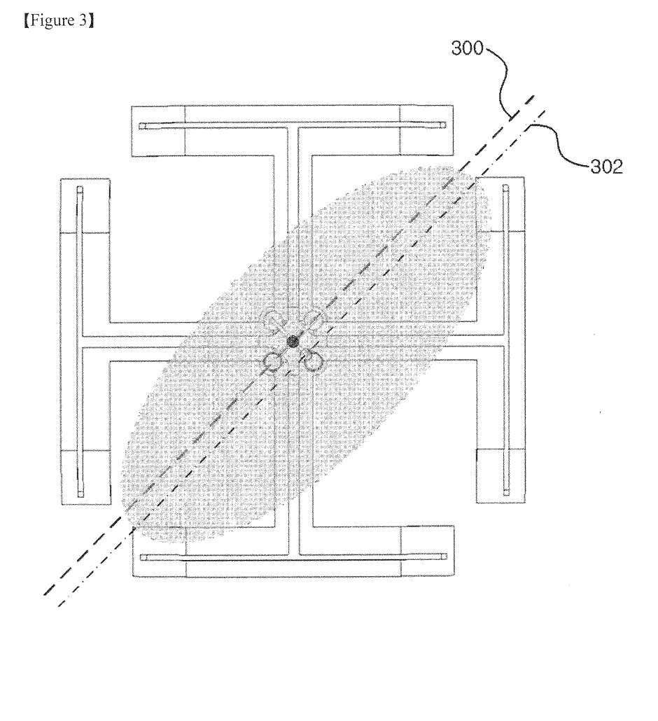

FIG. 4 is a plan view illustrating an antenna according to a first example embodiment of the present invention;

FIG. 5 is a plan view illustrating a phase difference of a current in the antenna in FIG. 4;

FIG. 6 is a plan view illustrating a radiation pattern of the antenna in FIG. 4;

FIG. 7 is a plan view illustrating an antenna to which a slit is formed;

FIG. 8 is a plan view illustrating a radiation pattern in accordance with the antenna in FIG. 7;

FIG. 9 is a plan view illustrating a radiation pattern in the antenna in a Related Art and a radiation pattern in the antenna of the present invention;

FIG. 10 is a plan view illustrating direction shift of a radiation pattern in an antenna according to one example embodiment of the present invention;

FIG. 11 is a plan view illustrating an antenna according to a second example embodiment of the present invention;

FIG. 12 is a plan view illustrating an antenna according to a third example embodiment of the present invention;

FIG. 13 is a plan view illustrating an antenna according to a fourth example embodiment of the present invention;

FIG. 14 is a plan view illustrating an antenna according to a fifth example embodiment of the present invention;

FIG. 15 is a plan view illustrating an antenna according to a sixth example embodiment of the present invention; and

FIG. 16 is a plan view illustrating an antenna according to a seventh example embodiment of the present invention.

### MODE FOR INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

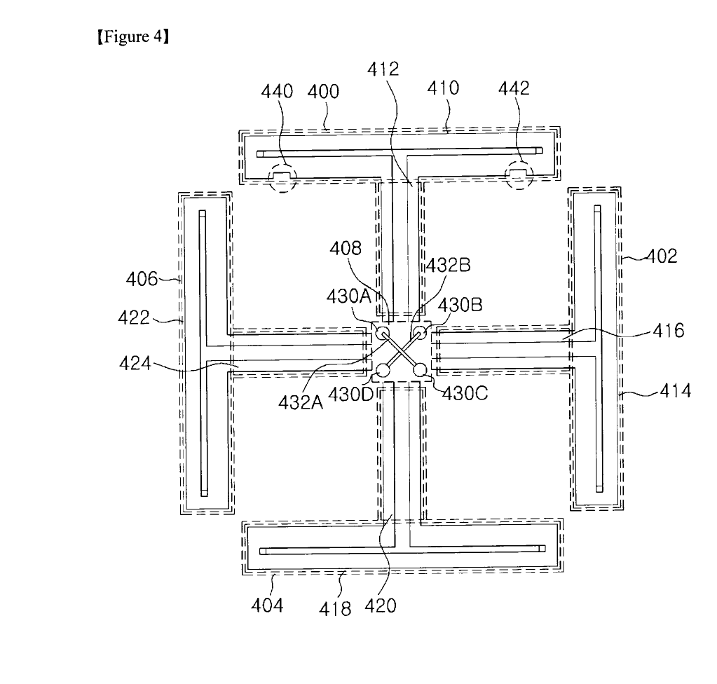

FIG. 4 is a plan view illustrating an antenna according to a first example embodiment of the present invention.

Referring to FIG. 4, the antenna of the present embodiment uses a vector composition method, and includes a first dipole member 400, a second dipole member 402, a third dipole member 404, a fourth dipole member 406 and a feeding section 408.

In one embodiment of the present invention, the antenna is a dual polarization antenna for generating dual polarization using the vector composition method. Here, the dipole members 400, 402, 404 and 406 are for example folded dipole members. In addition, the dipole members 400, 402, 404 and 406 have square structure as shown in FIG. 4. Hereinafter, it is assumed that the dipole members 400, 402, 404 and 406 are folded dipole members for convenience of description.

The feeding section 408 has a first feeding point 430A, a second feeding point 430B, a third feeding point 430C, a fourth feeding point 430D, a first connection line 432A and a second connection line 432B.

The first feeding point 430A is connected to the first dipole member 400 and the fourth dipole member 406, and provides current inputted from an outside device to the first dipole member 400 and the fourth dipole member 406.

The second feeding point 430B is connected to the first dipole member 400 and the second dipole member 402, and provides current inputted from an outside device to the first dipole member 400 and the second dipole member 402.

The third feeding point 430C is connected to the second dipole member 402 and the third dipole member 404, and is connected to the first feeding point 430A through the first connection line 432A. Here, the current inputted to the first feeding point 430A is provided to the third feeding point 430C through the first connection line 432A.

The fourth feeding point 430D is connected to the third dipole member 404 and the fourth dipole member 406, and is connected to the second feeding point 430B through the second connection line 432B. Here, the current inputted to the second feeding point 430B is provided to the fourth feeding point 430D through the second connection line 432B.

In short, the currents for radiation pattern of the antenna of the present embodiment are not inputted every feeding point 430A, 430B, 430C and 430D but inputted to only two feeding points 430A and 430B. Then, the inputted currents are applied from the feeding points 430A and 430B to the feeding points 430C and 430D. That is, the antenna of the present embodiment uses a feeding method biased in a specific direction. This feeding method generates phase difference between the currents applied to the dipole members 400, 402, 404 and 406. Accordingly, the antenna of the present embodiment uses slits 440 and 442 as described below so as to compensate the phase difference. This will be described in detail with reference to accompanying drawings.

The first dipole member 400 includes a first radiation member 410 and a first feeding line member 412, and is connected to the first feeding point 430A and the second feeding point 430B. Therefore, some of the current inputted to the first feeding point 430A is applied to the first radiation member 410 through the first feeding line member 412.

To reduce phase difference of currents occurred by the feeding method biased in the specific direction, two slits 440 and 442 are for example symmetrically formed to the first dipole member 400 as shown in FIG. 4. Here, the slit 440 is formed to compensate a phase of +45° polarization, and the slit 442 is formed to compensate a phase of −45° polarization. On the other hand, the slit 440 may be affected to −45° polarization, and the slit 442 may be affected to +45° polarization.

Hereinafter, the slits 440 and 442 and a method of compensating a phase of a polarization using the slits 440 and 442 will be described in detail with reference to accompanying drawings.

The second dipole member 402 is connected to the second feeding point 430B and the third feeding point 430C, and includes a second radiation member 414 and a second feeding line member 416.

The third dipole member 404 is connected to the third feeding point 430C and the fourth feeding point 430D, and has a third radiation member 418 and a third feeding line member 420.

The fourth dipole member 406 is connected to the fourth feeding point 430D and the first feeding point 430A, and includes a fourth radiation member 422 and a fourth feeding line member 424. On the other hand, no slit is formed to the dipole members 402, 404 and 406.

Hereinafter, a method of compensating a phase of a radiation pattern using the slits 440 and 442 will be described in detail.

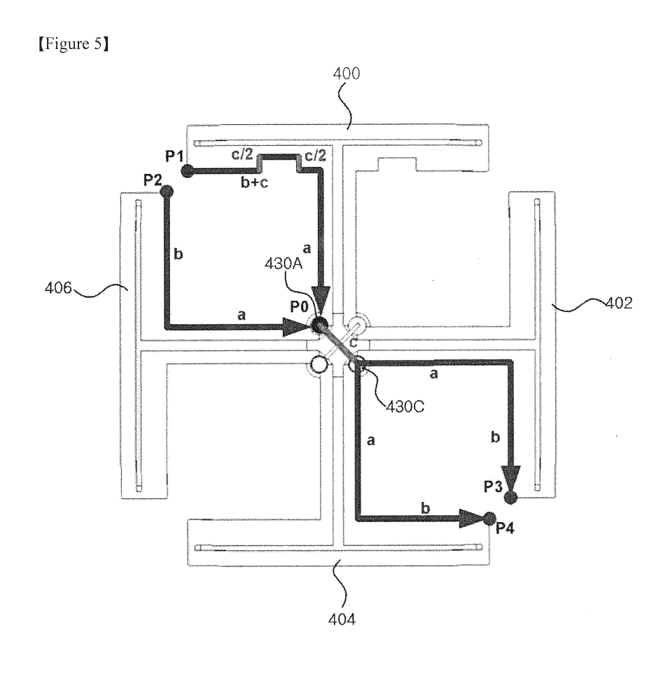

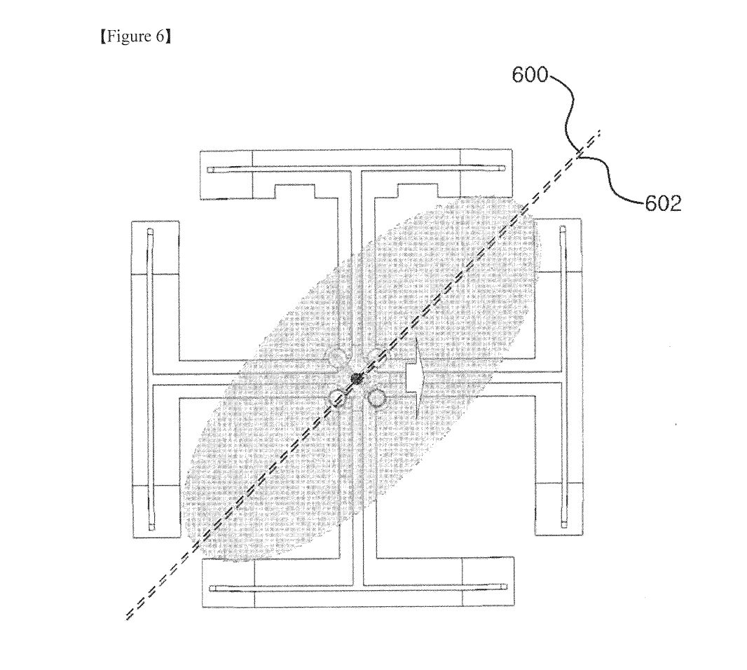

FIG. 5 is a plan view illustrating phase difference of a current in the antenna in FIG. 4. FIG. 6 is a plan view illustrating a radiation pattern of the antenna in FIG. 4.

As shown in FIG. 5, the current inputted to the first feeding point 430A is provided to the dipole members 400, 402, 404 and 406, and so a radiation pattern of +45° polarization is generated as shown in FIG. 6. In particular, electric field by a first sub-current provided to the first dipole member 400, electric field by a second sub-current applied to the second dipole member 402, electric field by a third sub-current provided to the third dipole member 404 and electric field by a fourth sub-current applied to the fourth dipole member 406 are vector-composed, and thus +45° polarization is generated. On the other hand, in case that a specific current is inputted to the second feeding point 430B, −45° polarization is generated.

Hereinafter, a method of compensating a phase will be described through +45° polarization for convenience of description.

A distance POP1 between the first feeding point 430A and an edge of the first dipole member 400, a distance POP3 between the first feeding point 430A and an edge of the second dipole member 402, and a distance POP4 between the first feeding point 430A and an edge of the third dipole member 404 are (a+b+c), respectively. As a result, a phase of the first sub-current provided from the first feeding point 430A to the first dipole member 400, a phase of the second sub-current provided from the first feeding point 430A to the second dipole member 402 and a phase of the third sub-current provided from the first feeding point 430A to the third dipole member 404 have substantially the same value.

That is, the antenna of the present embodiment makes the phases of the sub-currents have the same value by forming the first slit 440 to the first radiation member 410 of the first dipole member 400. On the other hand, a distance POP2 between the first feeding point 430A to an edge of the fourth dipole member 406 is different from the above distances as (a+b), and so a phase of the fourth sub-current provided to the fourth dipole member 406 from the first feeding point 430A is different from the above phases corresponding to the first to third sub-currents.

Unlike the antenna where a major axis of a radiation pattern is shifted in a right direction of +45° axis, a major axis 602 is substantially identical to +45° axis 600 as shown in FIG. 6 in the antenna of the present embodiment.

On the other hand, the radiation pattern may be changed in accordance with a frequency band of an electromagnetic wave transmitted/received from/to the antenna. Accordingly, a slit should be properly formed to a dipole member. In brief, the antenna of the present embodiment generates the radiation pattern using the vector composition method, and forms the slits 440 and 442 to a part of the dipole members 400, 402, 404 and 406, thereby compensating a shift phenomenon of a polarization due to a feeding method. As a result, direction of the radiation pattern of +45° polarization is substantially identical to that of the radiation pattern of −45° polarization, and thus a user may easily radiate a main beam in a desired direction.

Since the antenna radiates usually +45° polarization and −45° polarization, the slit 440 for compensating a shift of +45° polarization and the slit 442 for compensating a shift of −45° polarization are symmetrically formed to corresponding dipole member 400. Here, the slits 440 and 442 are formed to a part of the dipole members 400, 402 and 406 connected to the feeding points 430A and 430B to which current is inputted as described below.

In one example embodiment of the present invention, phases of at least three sub-currents of the current inputted to the first feeding point 430A have the same values so that the shift of the radiation pattern is compensated.

In other words, the antenna compensates a shift of the radiation pattern by using the slits 440 and 442 as shown in FIG. 5. However, various methods such as a method of forming a projection member, etc. may be used as long as phases of the sub-currents have the same value. Accordingly, it will be immediately obvious to those skilled in the art that the above many modifications of forming a slit do not have any effect to the scope of the present invention.

In the above FIG. 4, the slits 440 and 442 have a rectangular shape. However, the slits 440 and 442 may have various shapes such as a circular shape, a triangle shape, etc. as long as phase of a current is compensated.

In one example embodiment of the present invention, one of the slits 440 and 442 has a first shape, ant the other slit may have a second shape different from the first shape. That is, the shape of the slits 440 and 442 is not limited.

As described above, the shift phenomenon of the radiation pattern is compensated by forming the slits 440 and 442. Here, compensation degree is varied in accordance with width and depth of the slits 440 and 442. This will be described in detail with reference to accompanying drawings.

In the above FIG. 4, the slits 440 and 442 are formed to outline of the radiation member 110. However, the slits 440 and 442 may be formed to inner line of the radiation member 110 when the dipole member 400 is a folded dipole member.

Hereinafter, a case of forming a slit to a dipole member not connected to a feeding point to which current is inputted will be described in detail.

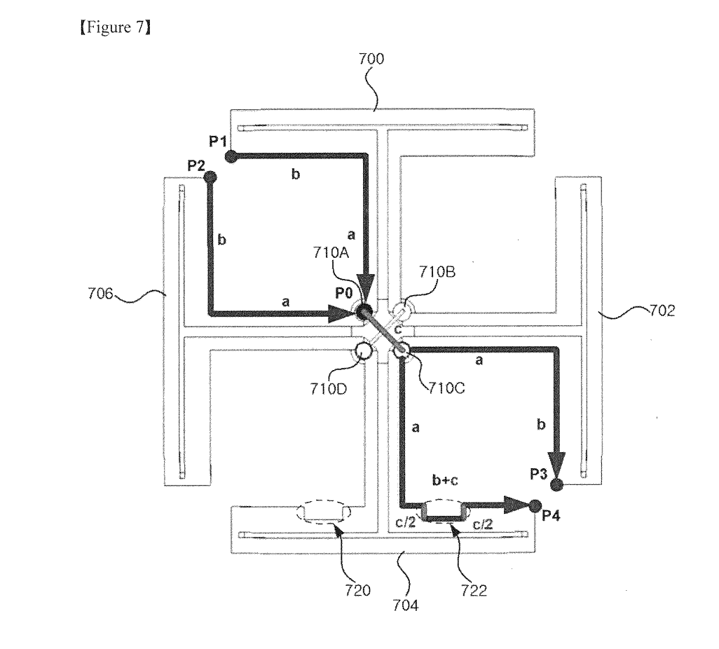

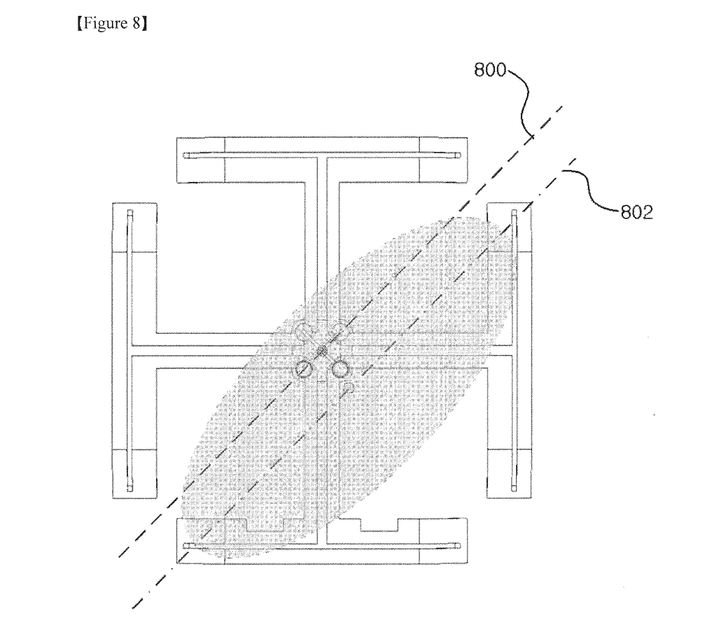

FIG. 7 is a plan view illustrating an antenna to which a slit is formed. FIG. 8 is a plan view illustrating a radiation pattern in accordance with the antenna in FIG. 7.

Referring to FIG. 7, the antenna includes a first dipole member 700, a second dipole member 702, a third dipole member 704, a fourth dipole member 706, a first feeding point 710A, a second feeding point 710B, a third feeding point 710C and a fourth feeding point 710D.

A first current is inputted to the first feeding point 710A, and then is applied from the first feeding point 710A to the third feeding point 710C.

A second current is inputted to the second feeding point 710B, and then is applied from the second feeding point 710B to the fourth feeding point 710D.

That is, the antenna uses a feeding method biased in a specific direction like the first embodiment.

Here, slits 720 and 722 are not formed at the dipole members 700, 702 and 704 connected to the feeding points 710A and 710B to which currents are inputted, and are formed to the third dipole member 710C not connected to the feeding points 710A and 710B. In this case, a distance POP1 between the first feeding point 710A and an edge of the first dipole member 700 and a distance POP2 between the first feeding point 710A and an edge of the fourth dipole member 706 are (a+b), respectively. However, a distance POP3 between the first feeding point 710A and an edge of the second dipole member 702 is (a+b+c), and a distance POP4 between the first feeding point 710A and an edge of the third dipole member 704 is (a+b+2c). As a result, a major axis 802 of a radiation pattern is more shifted in a right direction of +45° axis as shown in FIG. 8.

Accordingly, in the antenna of the present invention, a slit should be formed to a part of dipole members connected to a feeding point to which current is inputted as shown in FIG. 4.

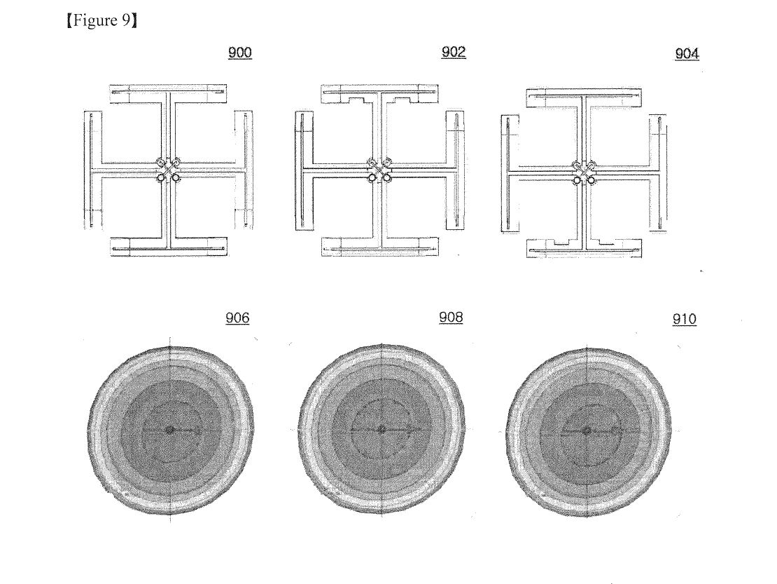

FIG. 9 is a plan view illustrating a radiation pattern in the antenna in a related art and a radiation pattern in the antenna of the present invention.

FIG. 9 shows the radiation pattern in the antenna 900 in related art, the radiation pattern in the antenna 902 of the present invention and the radiation pattern in the antenna 904 in FIG. 7 at 960 MHz.

A major axis of the radiation pattern 906 in the antenna 900 where a slit is not formed is shifted in a right direction of +45° axis as shown in FIG. 9. Whereas, a major axis of the radiation pattern 908 in the antenna 902 where a slit is formed to a dipole member connected to a feeding point to which current is inputted is substantially identical to +45° axis. In other words, the fact that a shift of the radiation pattern 908 in the antenna 902 of the present invention is compensated is verified through FIG. 9. However, in case of the antenna 904 where a slit is formed to a dipole member not connected to a feeding point to which current is inputted, a major axis of the radiation pattern 910 is more shifted in a right direction of +45° axis than in the antenna 900. Accordingly, it is verified that a slit should be formed to a dipole member connected to a feeding point to which current is inputted.

Generally, a shift phenomenon of the radiation pattern is more frequently occurred in a high frequency band than in a low frequency band. Accordingly, a slit is usually set for the purpose of compensating a shift of a radiation pattern in the high frequency band than in the low frequency band.

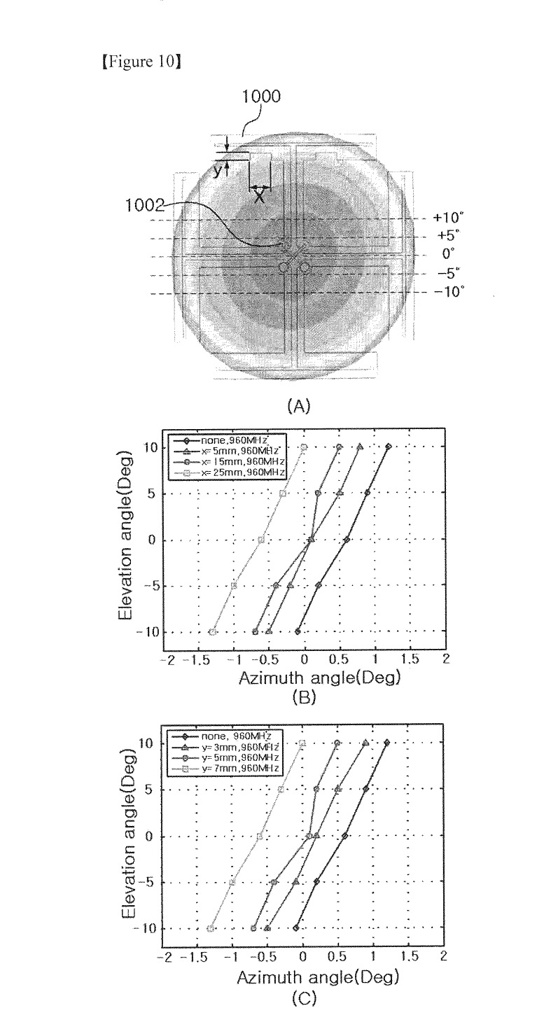

FIG. 10 is a plan view illustrating direction shift of a radiation pattern in an antenna according to one example embodiment of the present invention.

FIG. 10(A) shows the radiation pattern, FIG. 10(B) illustrates a shift of the radiation pattern in accordance with change of a width x of a slit, and FIG. 10(C) shows a shift of the radiation pattern in accordance with change of a depth y of the slit.

Referring to FIG. 10(B), it is verified that a shift of the radiation pattern in the antenna where the slit is formed becomes small compared to that of a radiation pattern in an antenna where the slit is not formed. In addition, in the antenna where the slit is formed, the radiation pattern is shifted according as the width x of the slit is changed.

For example, a major axis of the radiation pattern is shifted in a left direction according as the width x of the slit is increased. In this case, since length of a half of a dipole member 1000 is constant as b though the width x of the slit is changed, a distance between a dipole member 102 and an edge of the dipole member 1000 is constant if the depth y of the slit is constant. Accordingly, a phase of current provided from the feeding point 1002 to the dipole member 1000 should be constant irrespective of the width x of the slit, but the phase of the current is really changed as shown in FIG. 10(B) according as the width x of the slit is changed. This is because the slit affects to other dipole members. That is, since the radiation pattern is changed according as the width x of the slit is changed, a user may generate desired radiation pattern by adjusting the width x of the slit.

Referring to FIG. 10(C), it is verified that the radiation pattern is changed according as the depth y of the slit is changed.

In short, though whole length of the slit is constant, the radiation pattern may be changed in accordance with the width x and the depth y of the slit. Accordingly, the user changes properly the width x and the depth y in response to desired frequency band, thereby generating desired radiation pattern.

Specially, in case of an antenna used in wideband, radiation patterns in frequency bands should be not biased in a certain direction, and thus the width x and the depth y of the slit should be set to meet every frequency bands.

On the other hand, it is desired that the depth y of the slit is small and the width x of the slit has proper length when the width x and the depth y of the slit are set. This is because strength of the dipole member 1000 becomes weak when the depth y of the slit is high.

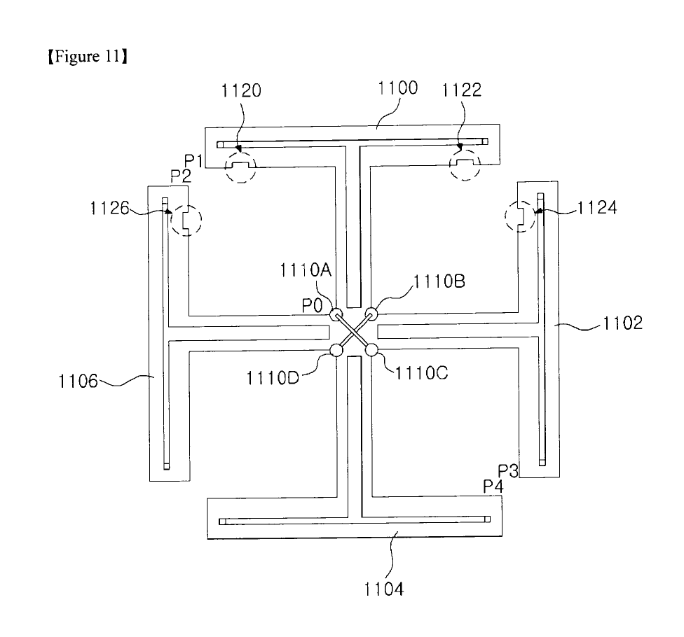

FIG. 11 is a plan view illustrating an antenna according to a second embodiment of the present invention.

In FIG. 11, the antenna of the present embodiment includes a first dipole member 1100, a second dipole member 1102, a third dipole member 1104, a fourth dipole member 1106, a first feeding point 1110A, a second feeding point 1110B, a third feeding point 1110C and a fourth feeding point 1110D.

In the antenna of the present embodiment, slits 1120, 1122, 1124 and 1126 are formed to the dipole members 1100, 1102 and 1106 connected to the feeding points 1110A and 1110B to which currents are inputted.

When a radiation pattern of +45° polarization is considered, a distance POP1 between the first feeding point 1110A and an edge of the first dipole member 1100, a distance POP3 between the first feeding point 1110A and an edge of the second dipole member 1102, a distance POP4 between the first feeding point 1110A and an edge of the third dipole member 1104 and a distance POP2 between the first feeding point 1110A and an edge of the fourth dipole member 1106 have that same lengths. As a result, phases of sub-currents passing from the first feeding point 1110A to the dipole members 1100, 1102, 1104 and 1106 have the same values, and so a major axis of the radiation pattern may be substantially identical to +45° axis.

Since a radiation pattern of −45° polarization is substantially identical to −45° axis like the above method, any further description concerning the radiation pattern of −45° axis will be omitted.

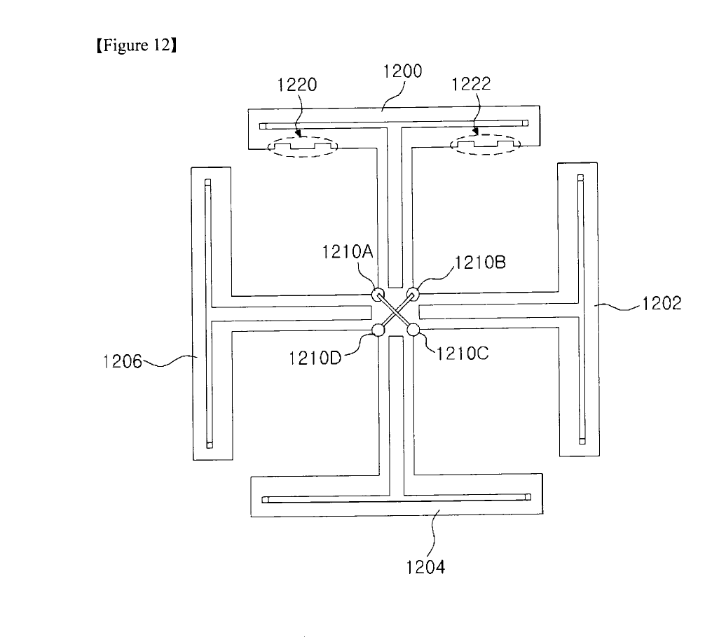

FIG. 12 is a plan view illustrating an antenna according to a third example embodiment of the present invention.

In FIG. 12, the antenna of the present embodiment includes a first dipole member 1200, a second dipole member 1202, a third dipole member 1204, a fourth dipole member 1206, a first feeding point 1210A, a second feeding point 1210B, a third feeding point 1210C and a fourth feeding point 1210D.

Since elements of the present embodiment except the first dipole member 1200 are the same as in the first embodiment, any further description concerning the same elements will be omitted.

At least two slits 1220 or 1222 may be formed to a half of a radiation member of the first dipole member 1200. Here, it is desirable that sum of depths of the slits 1220 or 1222 has the same length as for example a connection line which connects the first feeding point 1210A to the third feeding point 1210C.

Unlike the antenna in the first embodiment where only one slit is formed to a half of the dipole member, at least two slits 1220 or 1222 are formed to a half of the dipole member 1200 in the antenna of the third embodiment.

On the other hand, since the sum of the depths of the slits 1220 or 1222 is identical to a length of the connection line, the radiation in the third embodiment is similar to that in the first embodiment.

However, when the strength of the dipole member is considered, the strength of the antenna of the third embodiment where the slits 1220 or 1222 is formed to a half of the dipole member 1200 is better than that of the antenna in the first embodiment where one slit is formed to a half of the dipole member.

In FIG. 12, the slits 1220 and 1222 formed to the first dipole member 1200 have rectangular shape. However, the slits 1220 and 1222 may have other shape such as circular shape, etc.

In another embodiment of the present invention, one of the slits 1220 and 1222 has a first shape, e.g. rectangular shape, and the other slit has a second shape, e.g. triangle shape.

In still another embodiment of the present invention, one of the slits 1220 or 1222 has a third shape, e.g. rectangular shape, the other slit has a fourth shape, e.g. triangle shape. In other words, shape of the slits 1220 and 1222 is not limited.

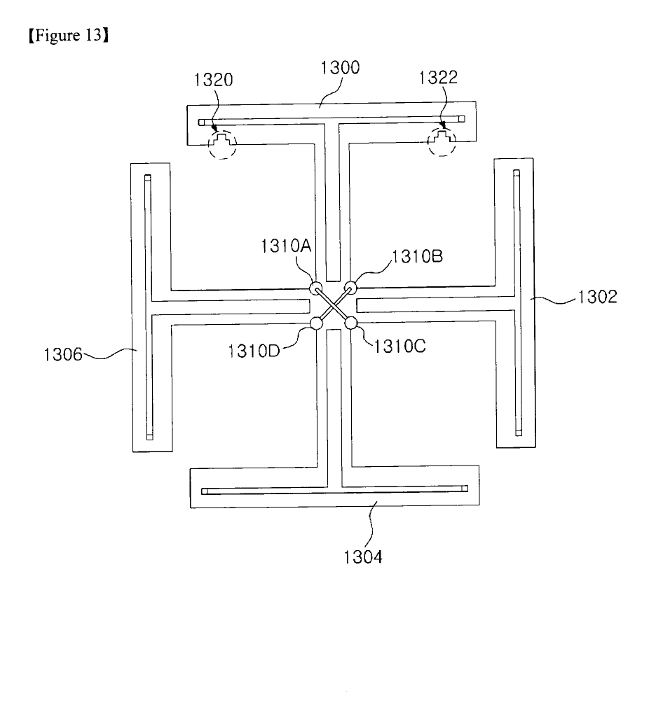

FIG. 13 is a plan view illustrating an antenna according to a fourth example embodiment of the present invention.

In FIG. 13, the antenna of the present embodiment includes a first dipole member 1300, a second dipole member 1302, a third dipole member 1304, a fourth dipole member 1306, a first feeding point 1310A, a second feeding point 1310B, a third feeding point 1310C and a fourth feeding point 1310D.

Since elements of the present embodiment except the first dipole member 1300 are the same as in the first embodiment, any further description concerning the same elements will be omitted.

124 Slits 1320 and 1322 having multi-step shape (Hereinafter, referred to as “multi-step slit”) are formed to a radiation member of the first dipole member 1300 as shown in FIG. 13. In this case, depth of the slit 1320 or 1322 may be the same as in the slit in the first embodiment though width of the slit 1320 or 1322 is smaller than that in the first embodiment.

In another embodiment of the present invention, one of the slits 1320 and 1322 has multi-step shape, and the other slit has a usual shape, e.g. rectangular shape, or circular shape, etc.

In still another embodiment of the present invention, multi-step slits may be respectively formed to dipole members connected to feeding points to which current is inputted like the second embodiment.

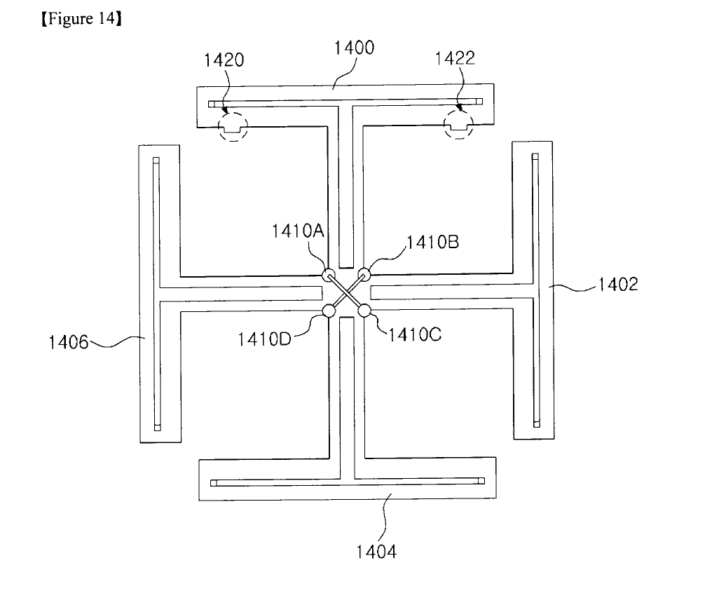

FIG. 14 is a plan view illustrating an antenna according to a fifth example embodiment of the present invention.

In FIG. 14, the antenna of the present embodiment includes a first dipole member 1400, a second dipole member 1402, a third dipole member 1404, a fourth dipole member 1406, a first feeding point 1410A, a second feeding point 1410B, a third feeding point 1410C and a fourth feeding point 1410D.

Since elements of the present embodiment except the first dipole member 1400 are the same as in the first embodiment, any further description concerning the same elements will be omitted.

Projection members 1420 and 1422 are formed to a radiation member of the first dipole member 1400.

In this case, since a distance between the first feeding point 1410D and an edge of the first dipole member 1400 is increased like the above antenna where the slit is formed to the radiation member, a phase of corresponding current is compensated. Accordingly, a shift phenomenon of a radiation pattern is not occurred.

Here, since the slit and the projection member compensate phase of corresponding current, the slit and the projection member may be nominated as phase compensating section.

In FIG. 14, the projection member 1420 or 1422 is formed to only the radiation member of the first dipole member 1400. However, the projection member 1420 or 1422 may be formed to various locations with various shapes, e.g. rectangular shape, circular shape, multi-step shape, etc. like the antennas in the second to fourth embodiments.

In another embodiment of the present invention, a projection member is formed to a half of a given dipole member, and a slit may be formed to the other half.

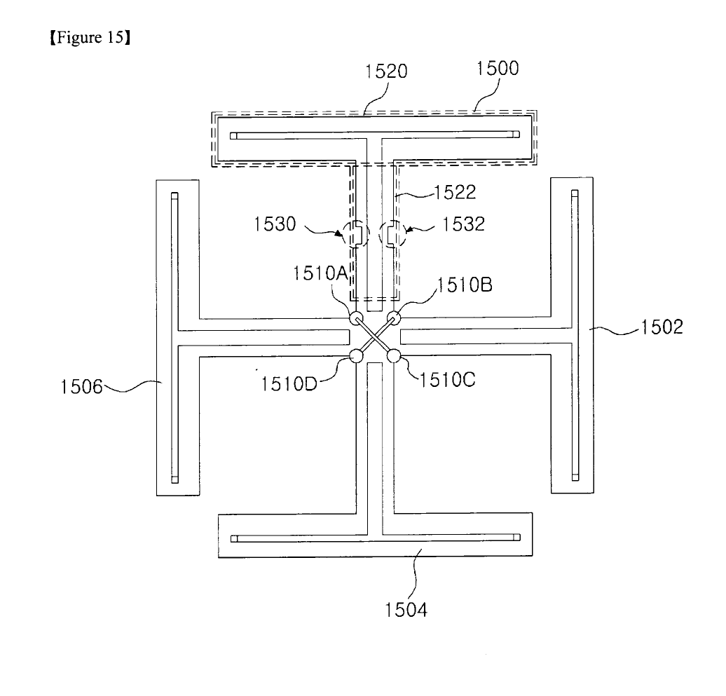

FIG. 15 is a plan view illustrating an antenna according to a sixth example embodiment of the present invention.

In FIG. 15, the antenna of the present embodiment includes a first dipole member 1500, a second dipole member 1502, a third dipole member 1504, a fourth dipole member 1506, a first feeding point 1510A, a second feeding point 1510B, a third feeding point 1510C and a fourth feeding point 1510D.

Since elements of the present embodiment except the first dipole member 1500 are the same as in the first embodiment, any further description concerning the same elements will be omitted.

The first dipole member 1500 is made up of a radiation member 1520 and a feeding line member 1522.

Slits 1530 and 1532 are formed to the feeding line member 1522 as shown in FIG. 15. As a result, since a distance between the first feeding point 1510A and an edge of the radiation member 1520 is increased, a phase of current passing from the first feeding point 1510A to the radiation member 1520 may be compensated.

In brief, unlike the antennas in the first to fourth embodiments where the slit is formed to the radiation member of the dipole member, the slit is formed to the feeding line member of the dipole member in the antenna in the sixth embodiment.

Really, the antenna where the slit is formed to the feeding line member is better than the antenna where the slit is formed to the radiation member in view of compensation of the phase. On the other hand, a process of forming the slit to the feeding line member may be more difficult than that of forming the slit to the radiation member. However, the strength of the radiation member 1520 in the sixth embodiment may be excellent than those of the radiation members in the first to fourth embodiments.

In FIG. 15, the slits 1530 and 1532 are formed to only the first dipole member 1500. However, the slits 1530 and 1532 may be formed to various locations with various shapes like the first to fourth embodiments.

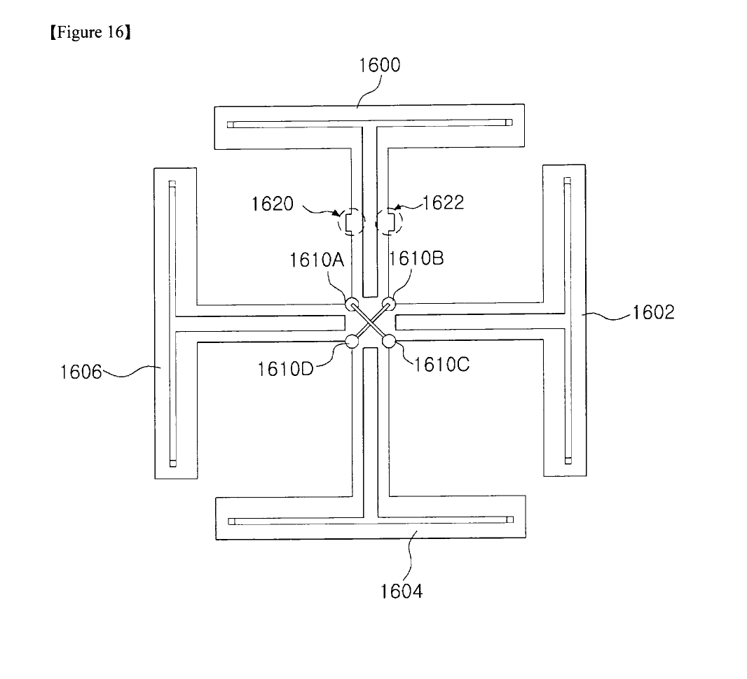

FIG. 16 is a plan view illustrating an antenna according to a seventh example embodiment of the present invention.

In FIG. 16, the antenna of the present embodiment includes a first dipole member 1600, a second dipole member 1602, a third dipole member 1604, a fourth dipole member 1606, a first feeding point 1610A, a second feeding point 1610B, a third feeding point 1610C and a fourth feeding point 1610D.

Since elements of the present embodiment except the first dipole member 1600 are the same as in the sixth embodiment, any further description concerning the same elements will be omitted.

Projection members 1620 and 1622 may be formed to a feeding line member of the first dipole member 1600 as shown in FIG. 16. However, location and shape of the projection members 1620 and 1622 in the present embodiment are not limited.

In the above first to seventh embodiments, each of the antennas is a single device. However, the antenna may be used as one of radiation devices included in an array antenna. In this case, a user forms a slit and/or a projection member to a part of radiation devices, thereby adjusting direction of a beam pattern of the array antenna. Here, the radiation devices may be the same shape, or at least one radiation device may have different shape from the other radiation devices.

In one embodiment of the present invention, location and shape of a slit (projection member) formed to at least one of the radiation devices may be different from those of the other radiation devices.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An antenna comprising:
dipole members; and
a feeding section connected to the dipole members, and configured to have at least two feeding points,
wherein a first feeding point of the feeding points is connected to a second feeding point of the feeding points, a first sub-current of a current inputted to the first feeding point from an outside device is applied to a first dipole member coupled to the first feeding point, a second sub-current of the current is applied to a second dipole member through the first feeding point and the second feeding point, and at least one phase compensating section for compensating phase of the first sub-current is formed to the first dipole member.

2. The antenna of claim 1, wherein the phase compensating section is a slit or a projection member.

3. The antenna of claim 2, wherein the slit or the projection member has multi-step shape.

4. The antenna of claim 1, wherein the first dipole member includes:
a radiation member; and
a feeding line member configured to connect the radiation member to the first feeding point,
wherein the phase compensating section is formed to one or more of the radiation member and the feeding line member.

5. The antenna of the claim 4, wherein at least two phase compensating sections are formed to the radiation member or the feeding line member.

6. The antenna of claim 1, wherein the feeding section further includes a connection line for connecting the first feeding point to the second feeding point,
wherein sum of depths of the phase compensating sections is substantially identical to length of the connection line.

7. The antenna of claim 1, wherein the feeding section further includes a connection line for connecting the first feeding point to the second feeding point,
wherein a first dipole member connected to the first feeding point includes:
a first radiation member; and
a first feeding line member configured to connect the first radiation member to the first feeding point,
wherein a second dipole member connected to the second feeding point includes:
a second radiation member; and
a second feeding line member configured to the second radiation member to the second feeding point,
and wherein a distance between the first feeding point and an edge of the first radiation member is substantially identical to that between the first feeding point and an edge of the second radiation member.

8. The antenna of claim 1, wherein the feeding section further includes a connection line for connecting the first feeding point to the second feeding point,
wherein a first dipole member connected to the first feeding point includes:
a first radiation member; and
a first feeding line member configured to connect the first radiation member to the first feeding point,
wherein a second dipole member connected to the second feeding point includes:
a second radiation member; and
a second feeding line member configured to the second radiation member to the second feeding point,
and wherein a phase of the first sub-current applied from the first feeding point to an edge of the first radiation member is substantially identical to that of the second sub-current applied from the first feeding point to an edge of the second radiation member.

9. The antenna of claim 1, wherein the feeding section further includes:
a first connection line configured to connect the first feeding point to the second feeding point;
a third feeding point;
a fourth feeding point; and
a second connection line configured to connect the third feeding point to the fourth feeding point,
and wherein the second connection line crosses over the first connection line, given current is provided to the fourth feeding point through the third feeding point, a first phase compensating section is formed to a first radiation member connected to the first feeding point, a second phase compensating section is formed to a second radiation member connected to the third feeding point, and the first phase compensating section and the second phase compensating section are symmetrically disposed.

10. The antenna of claim 1, wherein the dipole members include a first folded dipole member to a fourth folded dipole member,
wherein the feeding section includes:
a first feeding point connected to the first folded dipole member;
a second feeding point connected to the second folded dipole member;
a third feeding point connected to the third folded dipole member; and
a fourth feeding point connected to the fourth folded dipole member,
and wherein the second sub-current is provided to the second feeding point through the first feeding point, a third sub-current is provided to the fourth feeding point through the third feeding point, and a phase compensating section is formed to at least one of the first folded dipole member and the third folded dipole member.

11. The antenna of claim 10, wherein the phase compensating section is formed to at least one of an outline and inner line of corresponding folded dipole member

12. The antenna of claim 1, wherein the antenna is one of radiation devices included an array antenna.

13. An antenna comprising:
a first feeding point;
a second feeding point connected to the first feeding point;
a first dipole member and a second dipole member connected to the first feeding point; and
a third dipole member and a fourth dipole member connected to the second feeding point,
wherein at least three of a first current, a second current, a third current and a fourth current have the same phase,
and wherein the first current is provided from the first feeding point to an edge of the first dipole member, the second current is provided from the first feeding point to an edge of the second dipole member, the third current is provided from the first feeding point to an edge of the third dipole member through the second feeding point, and the fourth current is provided from the first feeding point to an edge of the fourth dipole member through the second feeding point.

14. The antenna of claim 13, wherein at least three of a first distance between the first feeding point and the edge of the first dipole member, a second distance between the first feeding point and the edge of the second dipole member, a third distance from the first feeding point and to the edge of the third dipole member through the second feeding point and a fourth distance from the first feeding point to the edge of the fourth dipole member through the second feeding point have the same length.

15. An antenna comprising:
a first feeding point;
a second feeding point connected to the first feeding point;
a first dipole member and a second dipole member connected to the first feeding point; and
a third dipole member and a fourth dipole member connected to the second feeding point,
wherein a give polarization is generated by summing a first electric field by a first current applied from the first feeding point to the first dipole member, a second electric field by a second current applied from the first feeding point to the second dipole member, a third electric field by a third current applied from the first feeding point to the third dipole member through the second feeding point and a fourth electric field by a fourth current applied from the first feeding point to the fourth dipole member through the second feeding point through a vector composition method,
and wherein phase of at least one of the currents is compensated so that a major axis of the generated polarization is substantially identical to a corresponding polarization axis.

16. The antenna of claim 15, wherein a slit or a projection member for compensating phase is formed to the first dipole member or the second dipole member,
and wherein width and depth (height) of the slit (projection member) is set so that the major axis of the generated polarization is substantially identical to a corresponding polarization axis.
